(19) United States
(12) Patent Application Publication
(10) Pub. No.: US 2005/0162634 A1
(43) Pub. Date: Jul. 28, 2005

(54) Cable tray assembly for precision drive stage

(75) Inventor: Mats Anders Engwall, San Juan Batista, CA (US)

Correspondence Address: BEYER WEAVER & THOMAS LLP, P.O. BOX 70250, OAKLAND, CA, 94612-0250, US

(73) Assignee: Nikon Corporation, Tokyo (JP)

(21) Appl. No.: 10/766,115

(22) Filed: Jan. 27, 2004

(51) Int. Cl. G03B 27/58

(52) U.S. Cl. 355/72; 355/75; 355/53; 310/10; 310/12; 318/649

(57) ABSTRACT

A cable tray assembly includes a wafer table placed on a precision drive stage of which motions along specified mutually perpendicular X- and Y-directions are independently controlled. A plurality of conduits such as electrical and/or optical cables and gas- and/or liquid-transporting tubes are attached to the wafer table at one end and are also attached to an end portion of a planar elongated member extending in the X-direction. This elongated member is made of an elastic material and has a naturally arcuate sectional shape in the Y-direction. The other end portion of this elongated member is wound around a shaft extended in the Y-direction. The rotary motion and the axial motion in the Y-direction of the shaft are controlled by the same signals which cause the drive stage to move in the X- and Y-directions by the same distances such that the drive stage and the wafer table will move in synchronism with each other, minimizing the effect of cable drag on the wafer table.

### BACKGROUND OF THE INVENTION

This invention relates to a precision motion device for accurately positioning a workpiece connected to a plurality of conduits.

Precision motion devices are well known. They are typically used in machine tools and other applications where two-dimensional precise movements are needed to position a workpiece. Where an electronic circuit for testing, for example, must thus be positioned accurately, the cable drag ( a combination of all forces and force moments including frictional and internal material friction forces) becomes a serious problem, whether occurring steadily or impulsively, because such a circuit must be connected to a power source and the testing process by the circuit may require a large amount of power, requiring large and heavy cables to transfer the required power. If the testing requires pneumatic pressure, pneumatic tubing coupling high pressure air from a source must be connected. If the heat generated by the complex processing circuitry is large, cooling liquids may have to be circulated from a heat exchanger. These cables, gas-carrying and liquid-carrying tubes and vacuum ducts are herein referred to as conduits. Not only do these bulky conduits get in the way of the operation, but they also interfere with the motion of a precision-requiring workpiece.

One application of such a precision motion device is as a stage used in lithography equipment for the manufacture of semiconductor integrated devices. In lithography systems, such a two-dimensionally mobile stage is typically used to position a semiconductor wafer. A lithography system includes a source of radiant energy for illumination such as a mercury lamp, other types of lamps, laser or electron-beam sources and a lens system to focus the radiation, which is directed through the reticle onto a substrate such as a semiconductor wafer. The lens system in a photolithography system is an optical lens system and in an electron-beam lithography system the lens system is an assembly of magnetic coils and/or electrostatic elements.

### SUMMARY OF THE INVENTION

The present invention overcomes the problems of prior art cable handling systems for a precision motion device and provides other additional advantages through a cable tray assembly for providing precise two-dimensional horizontal motion to a workpiece by eliminating the cable drag even where a bulky cable bundle including electrical cables and various gas-carrying and liquid-carrying tubes are attached to the cable tray.

A cable tray assembly according to an embodiment of the invention may be described as comprising a wafer table being placed on a drive stage and attached to conduits such as cables and tubes for electric power, gases or liquids, at least one planar elongated member of an elastic material with one end portion extending linearly in one of the directions in which the motion of the drive stage is controlled and being attached to these conduits connected to the wafer table, and a shaft around which the other end portion of the elongated member is wound. The shaft is rotatable around its own axis and also movable in the axial direction under the control of a control unit. The control unit controls the rotation and linear motion of the axis in correlation with the longitudinal motion of the drive stage. In other words, when a signal is issued to move the drive stage in the direction (X-direction) of extension of the elongated member, the shaft is correspondingly rotated to wind up or unwind the elongated member such that the wafer table will move by the same distance at the same time. Similarly, when a signal is issued to move the drive stage in the transverse direction which is parallel to the axial direction of the shaft, the shaft is moved in its axial direction simultaneously and by the same direction.

Two such elongated members may be provided, wound around a pair of shafts which are adapted to rotate simultaneously by the same angle in the same direction and to move axially simultaneously and by the same distance, both having conduits attached thereto and these conduits also being attached to the wafer table such that the wafer table is connected to the conduits from mutually opposite directions. With the motion of the drive stage and that of the wafer table thus correlated, the effect of cable drag can be minimized and accurate motion control becomes effective.

### BRIEF DESCRIPTION OF THE DRAWING

The invention, together with further objects and advantages thereof, may best be understood with reference to the following description taken in conjunction with the accompanying drawings in which:

FIG. 1 is a cross-sectional view of an exemplary lithographic exposure apparatus that incorporates the present invention.

FIG. 2 is a process flow diagram illustrating an exemplary process by which semiconductor devices are fabricated using the systems shown in FIG. 1 according to the present invention.

FIG. 3 is a flowchart of the wafer processing step shown in FIG. 2 in the case of fabricating semiconductor devices according to the present invention.

FIG. 4 is a schematic drawing of a portion of a precision motion device incorporating a cable tray assembly of this invention, including a block diagram for its control system.

FIG. 5 is a schematic sectional view of a cable tray with conduits attached to both surfaces.

### DETAILED DESCRIPTION OF THE INVENTION

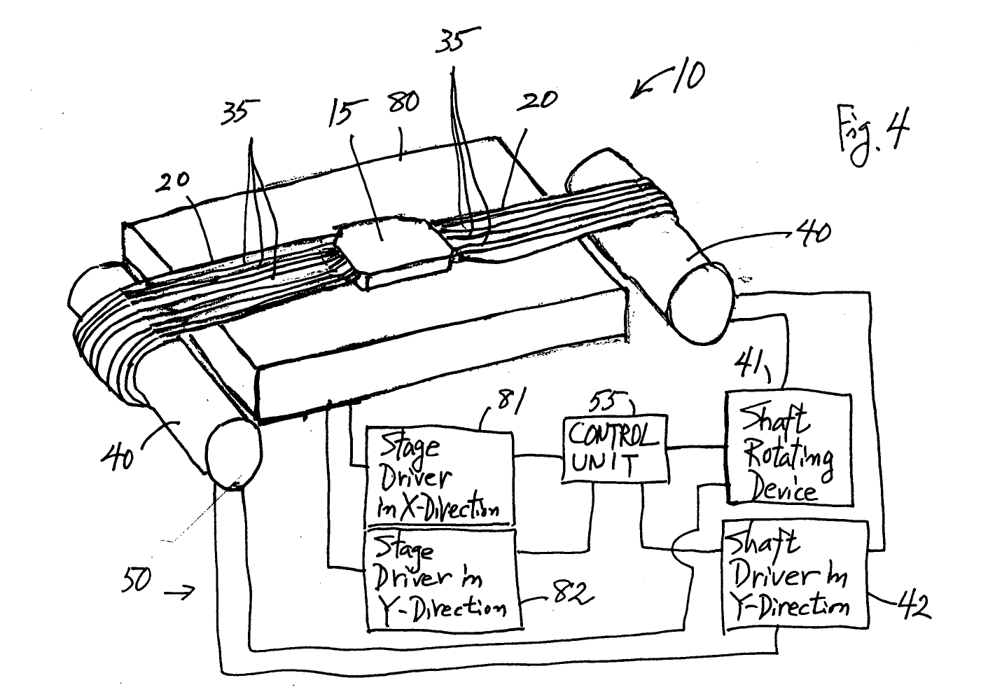

The invention will be described next by way of an example with reference to FIG. 4 showing schematically a cable tray assembly 10 embodying this invention as having a movable stage portion, or a wafer table 15, placed on top of a drive stage 80. The drive stage 80 is a so-called XY stage of a known kind, adapted to be controllably moved two-dimensionally in a horizontal plane, having independently controllable means such as two electromagnetic motors 52 and 54 for moving the stage 80 respectively in one specified linear horizontal direction (hereinafter referred to as the “longitudinal direction” and also as “the X-direction”) and in the perpendicular horizontal direction (hereinafter referred to as the “transverse direction” and also as “the Y-direction”). Since the drive stage 80 itself is not a part of the present invention, device components for its motion are neither illustrated in FIG. 4 nor described in any detail herein.

The cable tray assembly 10 includes a wafer table 15, which is placed on top of the drive stage 80 and is intended to move in synchronism with the drive stage 80. A pair of elongated strips of an elastic material such as steel (hereinafter referred to as the “cable trays” 20) is connected to mutually opposite sides of the wafer table 15, extending horizontally in mutually opposite directions in the aforementioned X-direction. Each of the cable trays 20 has end portions of many conduits 35 attached to one or both of its surfaces (although FIG. 4 shows the conduits 35 attached to only one surface of each of the cable trays 20 for the convenience of disclosure). These conduits 35 have one end connected to the wafer table 15 and may include electrical cables for supplying electrical power, optical cables for transmitting light signals, tubes for passing a high-pressure gas to the wafer table 15 and/or tubes for circulating cooling liquids to the wafer table 15, the other ends of these conduits 35 being connected to corresponding external devices (not shown). While the conduits 35 are themselves directly connected to the wafer table 15, the cable trays 20 are preferably not directly connected to the wafer table 15, but only indirectly through the conduits 35, as can be seen in FIG. 4. This is in order to minimize whatever cable drag there may be and to provide additional compliance.

As shown schematically in FIG. 5, each of the cable trays 20 has a naturally arcuate sectional shape, as seen in the longitudinal direction, like a carpenter's measuring tape. FIG. 5 shows an example wherein the conduits 35 are attached to both surfaces of the cable tray 20. The other end, distal from the wafer table 15, of each of these cable trays 20 is wound around a shaft 40 extending horizontally in the Y-direction. The unrolled portions of these cable trays 20 having a naturally arcuate sectional shape possess considerable lateral and flexural stiffness. The curvature of the sectional shape may be, for example, such that the width (or the transverse dimension) of the cable tray 20 is about 10 cm and the side edges are higher than a center position by about 1 cm although these dimensions are not intended to limit the scope of the invention.

FIG. 4 is in part a block diagram for showing a control system 50 for controlling the motion of the cable tray assembly 10 structured as generally described above, as well as the drive stage 80. As mentioned above, the drive stage 80 itself is not a part of the present invention. As long as the present invention is concerned, the drive stage 80 is adapted to be individually controlled to move in the X-direction and the Y-direction. Devices for thus controlling the linear motions of the drive stage 80 in the X-direction and the Y-direction are respectively referred to as the “stage driver in X direction” 81 and the “stage driver in Y-direction” 82. They may each comprise a motor and a motion-transmitting mechanism of a known kind.

In FIG. 4, numeral 41 generally indicates a shaft-rotating device for rotating the shafts 40 in synchronism with each other such that one of the cable trays 20 is unwound from the corresponding one of the shafts 40 while the other of the cable trays 20 is wound around the other of the shafts 40 at the same rate, thereby causing the wafer table 15 attached through the conduits 35 to both of these cable trays 20 to move in the X-direction at a specified rate. Both of these shafts 40 are also adapted to move linearly in the Y-direction in synchronism and at the same rate with respect to each other such that the cable trays 20 remain extended in the X-direction, independent of the motion of the shafts 40 in the Y-direction. In FIG. 4, the mechanism for thus moving the shafts 40 in the Y-direction is referred to as the “shaft driver in Y-direction” 42. Any known combination of a motor or motors and a motion-transmitting mechanism of a known kind may be used as the shaft-rotating device 41 or the shaft driver in Y-direction 42.

As shown in FIG. 4, the control system 50 comprises a control unit 55 adapted to control not only the two-dimensional motion of the drive stage 80 through the stage driver in X direction 81 and the stage driver in Y-direction 82 but also the rotary motion of the shafts 40 through the shaft rotating device 41 and the linear motion of the shafts 40 in the Y-direction through the shaft driver in Y-direction 42 in synchronism. Explained more in detail, whenever the control unit 55 issues a signal to the stage driver in X-direction 81 to move the stage 80 by a specified distance in the X-direction, the control unit 55 also issues simultaneously a corresponding signal to the shaft rotating device 41 to cause the shafts 40 to rotate such that their rotations will cause the wafer table 15 to move in the X-direction simultaneously and by the same distance. The above may alternatively be said that the same signal by which the stage 80 is moved also serves to control the motion of the wafer table 15. Similarly, whenever the control unit 55 issues a signal to the stage driver in Y-direction 82 to move the stage 80 by a specified distance in the Y-direction, the control unit 55 also issues simultaneously a corresponding signal to the shaft driver in Y-direction 42, or the same signal is shared by the stage driver in Y-direction 82 and the shaft driver in Y-direction 42, to cause the shafts 40 to move in the Y-direction simultaneously and by the same distance. Thus, the drive stage 80 and the wafer table 15 are independently driven but move simultaneously in mutually correlated manners and without any relative displacement. In particular, since the wafer table 15 is independently driven, there is no unwanted effect of the so-called cable drag to adversely affect the motion of the wafer table 15 with respect to that of the drive stage although the conduits 35 carried by the cable trays 20 may be bulky.

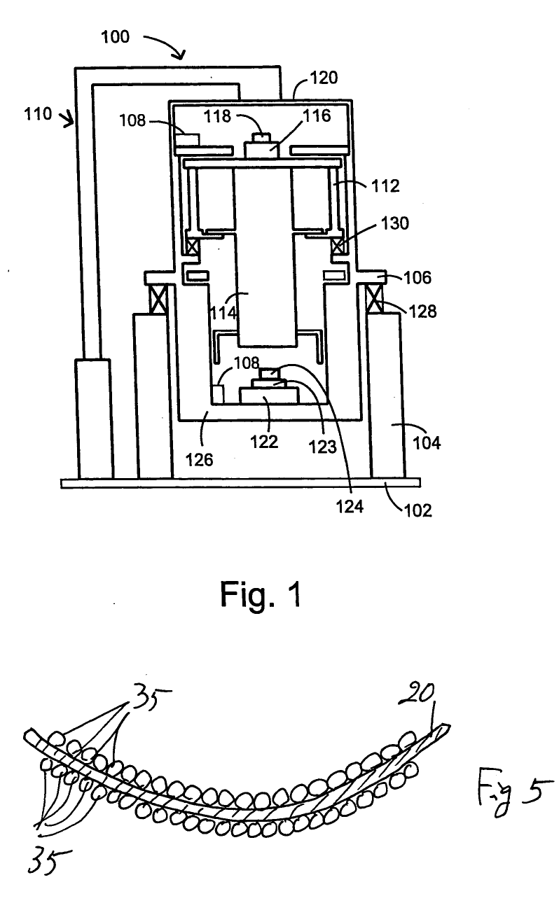

FIG. 1 shows a typical lithographic exposure apparatus 100 adapted to incorporate a cable tray assembly of this invention, comprising a mounting base 102, a support frame 104, a base frame 106, a measurement system 108, a control system (not shown), an illumination system 110, an optical frame 112, an optical device 114, a reticle stage 116 for retaining a reticle 118, an upper enclosure 120 surrounding the reticle stage 116, a wafer stage 122, a wafer table 123 for retaining a semiconductor wafer workpiece 124, and a lower enclosure 126 surrounding the wafer stage 122.

The support frame 104 typically supports the base frame 106 above the mounting base 102 through a base vibration isolation system 128. The base frame 106 in turn supports, through an optical vibration isolation system 130, the optical frame 112, the measurement system 108, the reticle stage 116, the upper enclosure 120, the optical device 114, the wafer stage 122, the wafer table 123 and the lower enclosure 126 above the base frame 106. The optical frame 112 in turn supports the optical device 114 and the reticle stage 116 above the base frame 106 through the optical vibration isolation system 130. As a result, the optical frame 112, the components supported thereby and the base frame 106 are effectively attached in series through the base vibration isolation system 128 and the optical vibration isolation system 130 to the mounting base 102. The vibration isolation systems 128 and 130 are designed to damp and isolate vibrations between components of the exposure apparatus 100 and comprise a vibration damping device of this invention described above. The measurement system 108 monitors the positions of the stages 116 and 122 relative to a reference such as the optical device 114 and outputs position data to the control system. The optical device 114 typically includes a lens assembly that projects and/or focuses the light or beam from the illumination system 110 that passes through the reticle 118. The reticle stage 116 is attached to one or more movers (not shown) directed by the control system to precisely position the reticle 118 relative to the optical device 114. Similarly, the wafer stage 122 includes one or more movers (not shown) to precisely position the wafer workpiece 124 with the wafer table 123 relative to the optical device (lens assembly) 114.

As will be appreciated by those skilled in the art, there are a number of different types of photolithographic devices. For example, exposure apparatus 100 can be used as a scanning type photolithography system which exposes the pattern from reticle 118 onto wafer 124 with reticle 118 and wafer 124 moving synchronously. In a scanning type lithographic device, reticle 118 is moved perpendicular to an optical axis of optical device 114 by reticle stage 116 and wafer 124 is moved perpendicular to an optical axis of optical device 114 by wafer stage 122. Scanning of reticle 118 and wafer 124 occurs while reticle 118 and wafer 124 are moving synchronously.

Alternatively, exposure apparatus 100 can be a step-and-repeat type photolithography system that exposes reticle 118 while reticle 118 and wafer 124 are stationary. In the step and repeat process, wafer 124 is in a constant position relative to reticle 118 and optical device 114 during the exposure of an individual field. Subsequently, between consecutive exposure steps, wafer 124 is consecutively moved by wafer stage 122 perpendicular to the optical axis of optical device 114 so that the next field of semiconductor wafer 124 is brought into position relative to optical device 114 and reticle 118 for exposure. Following this process, the images on reticle 118 are sequentially exposed onto the fields of wafer 124 so that the next field of semiconductor wafer 124 is brought into position relative to optical device 114 and reticle 118.

However, the use of exposure apparatus 100 provided herein is not limited to a photolithography system for a semiconductor manufacturing. Exposure apparatus 100, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern by closely locating a mask and a substrate without the use of a lens assembly. Additionally, the present invention provided herein can be used in other devices, including other semiconductor processing equipment, machine tools, metal cutting machines, and inspection machines. The present invention is desirable in machines where it is desirable to prevent the transmission of vibrations.

The illumination source (of illumination system 110) can be g-line (436 nm), i-line (365 nm), Kef exciter laser (248 nm), Arc exciter laser (193 nm) and F₂ laser (157 nm). Alternatively, the illumination source can also use charged particle beams such as x-ray and electron beam. For instance, in the case where an electron beam is used, thermionic emission type lanthanum hex boride (LaB₆,) or tantalum (Ta) can be used as an electron gun. Furthermore, in the case where an electron beam is used, the structure could be such that either a mask is used or a pattern can be directly formed on a substrate without the use of a mask.

With respect to optical device 114, when far ultra-violet rays such as the exciter laser is used, glass materials such as quartz and fluorite that transmit far ultra-violet rays is preferably used. When the F₂ type laser or x-ray is used, optical device 114 should preferably be either catadioptric or refractive (a reticle should also preferably be a reflective type), and when an electron beam is used, electron optics should preferably comprise electron lenses and deflectors. The optical path for the electron beams should be in a vacuum.

Also, with an exposure device that employs vacuum ultra-violet radiation (VUV) of wavelength 200 nm or lower, use of the catadioptric type optical system can be considered. Examples of the catadioptric type of optical system include the disclosure Japan Patent Application Disclosure No. 8-171054 published in the Official Gazette for Laid-Open Patent Applications and its counterpart U.S. Pat. No. 5,668,672, as well as Japan Patent Application Disclosure No. 10-20195 and its counterpart U.S. Pat. No. 5,835,275. In these cases, the reflecting optical device can be a catadioptric optical system incorporating a beam splitter and concave mirror. Japan Patent Application Disclosure No. 8-334695 published in the Official Gazette for Laid-Open Patent Applications and its counterpart U.S. Pat. No. 5,689,377 as well as Japan Patent Application Disclosure No. 10-3039 and its counterpart U.S. Pat. No. 5,892,117 also use a reflecting-refracting type of optical system incorporating a concave mirror, etc., but without a beam splitter, and can also be employed with this invention. The disclosures in the above mentioned U.S. patents, as well as the Japan patent applications published in the Official Gazette for Laid-Open Patent Applications are incorporated herein by reference.

Further, in photolithography systems, when linear motors (see U.S. Pat. Nos. 5,623,853 or 5,528,118) are used in a wafer stage or a reticle stage, the linear motors can be either an air levitation type employing air bearings or a magnetic levitation type using Lorentz force or reactance force. Additionally, the stage could move along a guide, or it could be a guideless type stage which uses no guide. The disclosures in U.S. Pat. Nos. 5,623,853 and 5,528,118 are incorporated herein by reference.

Alternatively, one of the stages could be driven by a planar motor, which drives the stage by electromagnetic force generated by a magnet unit having two-dimensionally arranged magnets and an armature coil unit having two-dimensionally arranged coils in facing positions. With this type of driving system, either one of the magnet unit or the armature coil unit is connected to the stage and the other unit is mounted on the moving plane side of the stage.

Movement of the stages as described above generates reaction forces which can affect performance of the photolithography system. Reaction forces generated by the wafer (substrate) stage motion can be mechanically released to the floor (ground) by use of a frame member as described in U.S. Pat. No. 5,528,118 and published Japanese Patent Application Disclosure No. 8-166475. Additionally, reaction forces generated by the reticle (mask) stage motion can be mechanically released to the floor (ground) by use of a frame member as described in U.S. Pat. No. 5,874,820 and published Japanese Patent Application Disclosure No. 8-330224. The disclosures in U.S. Pat. Nos. 5,528,118 and 5,874,820 and Japanese Patent Application Disclosure No. 8-330224 are incorporated herein by reference.

As described above, a photolithography system according to the above described embodiments can be built by assembling various subsystems, including each element listed in the appended claims, in such a manner that prescribed mechanical accuracy, electrical accuracy and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, total adjustment is performed to make sure that every accuracy is maintained in the complete photolithography system. Additionally, it is desirable to manufacture an exposure system in a clean room where the temperature and humidity are controlled.

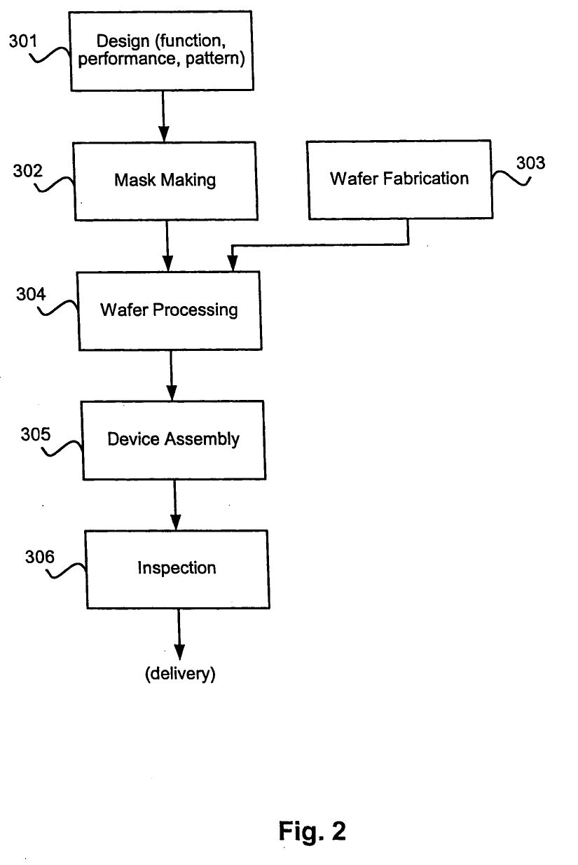

Further, semiconductor devices can be fabricated using the above described systems, by the process shown generally in FIG. 2. In step 301 the device's function and performance characteristics are designed. Next, in step 302, a mask (reticle) having a pattern is designed according to the previous designing step, and in a parallel step 303, a wafer is made from a silicon material. The mask pattern designed in step 302 is exposed onto the wafer from step 303 in step 304 by a photolithography system such as the systems described above. In step 305 the semiconductor device is assembled (including the dicing process, bonding process and packaging process), then finally the device is inspected in step 306.

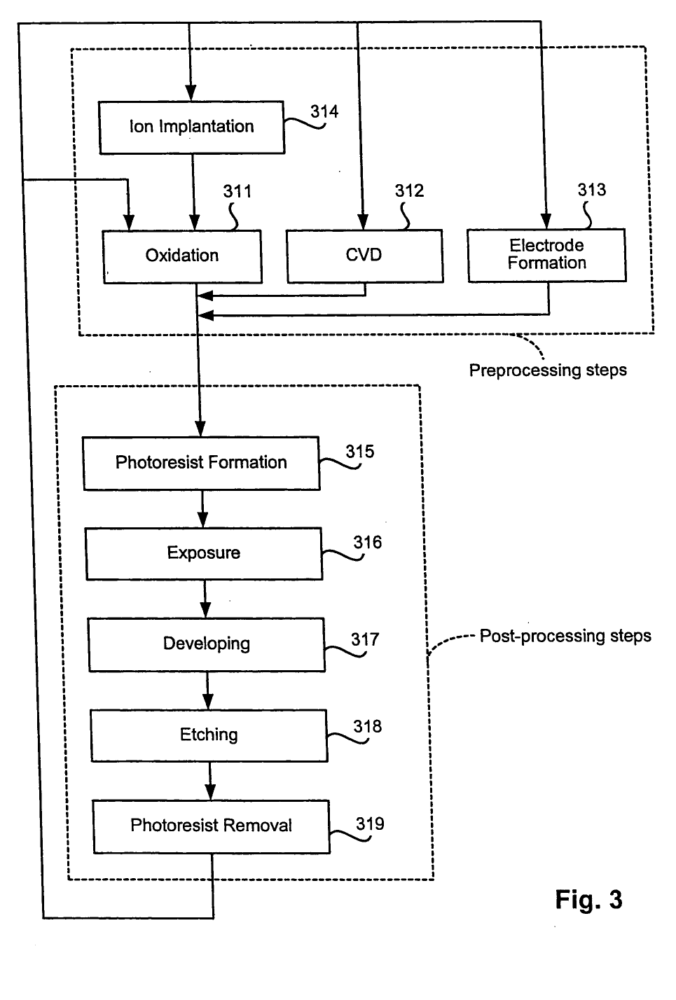

FIG. 3 illustrates a detailed flowchart example of the above-mentioned step 304 in the case of fabricating semiconductor devices. In step 311 (oxidation step), the wafer surface is oxidized. In step 312 (CVD step), an insulation film is formed on the wafer surface. In step 313 (electrode formation step), electrodes are formed on the wafer by vapor deposition. In step 314 (ion implantation step), ions are implanted in the wafer. The above mentioned steps 311-314 form the preprocessing steps for wafers during wafer processing, and selection is made at each step according to processing requirements.

At each stage of wafer processing, when the above-mentioned preprocessing steps have been completed, the following post-processing steps are implemented. During post-processing, initially, in step 315 (photoresist formation step), photoresist is applied to a wafer. Next, in step 316, (exposure step), the above-mentioned exposure device is used to transfer the circuit pattern of a mask (reticle) to a wafer. Then, in step 317 (developing step), the exposed wafer is developed, and in step 318 (etching step), parts other than residual photoresist (exposed material surface) are removed by etching. In step 319 (photoresist removal step), unnecessary photoresist remaining after etching is removed. Multiple circuit patterns are formed by repetition of these preprocessing and post-processing steps.

It should be appreciated that the example of the present invention described above by referring to FIGS. 4 and 5 may be utilized and/or incorporated in apparatus and methods described with reference to FIGS. 1-3.

1. A cable tray assembly for a precision drive stage, said drive stage having a stage motion controlling unit that controls motion of said drive stage in a specified longitudinal direction and a transverse direction which is perpendicular to said longitudinal direction; said cable tray assembly comprising;
a table placed on said drive stage;
a shaft extending in said transverse direction;
a planar elongated member with one end portion extending in said longitudinal direction and the opposite end portion attached to and wound around said shaft, said elongated member being made of an elastic material and having a naturally arcuate sectional shape in said transverse direction;
a plurality of conduits each attached to said one end portion of said elongated member and to said table at one end; and
a shaft motion controlling system for controlling rotation and axial motion of said shaft in correlation with a motion of said drive stage by said stage motion controlling unit.

2. The cable tray assembly of claim 1 comprising a pair of shafts extending in said transverse direction and said planar elongated member is one of a pair of similarly structured elongated members each with one end portion extending in said longitudinal direction and having conduits attached thereto and the opposite end portion wound around a corresponding one of said shafts.

3. The cable tray assembly of claim 1 wherein said stage motion controlling unit includes a longitudinal stage motion controlling device that controls motion of said drive stage in said longitudinal direction and said shaft motion controlling system includes a rotation controlling device that controls rotation of said shaft such that said table moves in said longitudinal direction and said shaft rotates to wind or unwind said elongated member around or from said shaft so as to move said table in said longitudinal direction by a same specified longitudinal distance by which said stage motion controlling unit moves said drive stage in said longitudinal direction.

4. The cable tray assembly of claim 1 wherein said stage motion controlling unit includes a transverse stage motion controlling device that controls motion of said drive stage in said transverse direction and said shaft motion controlling system includes a transverse motion controlling device that controls motion of said shaft in said transverse direction such that said table and said shaft move in said transverse direction by a same specified transverse distance.

5. The cable tray assembly of claim 3 wherein said stage motion controlling unit includes a transverse stage motion controlling device that controls motion of said drive stage in said transverse direction and said shaft motion controlling system includes a transverse motion controlling device that controls motion of said shaft in said transverse direction such that said table and said shaft move in said transverse direction by a same specified transverse distance.

6. The cable tray assembly of claim 2 wherein said stage motion controlling unit includes a longitudinal stage motion controlling device that controls motion of said drive stage in said longitudinal direction and said shaft motion controlling system includes a rotation controlling device that controls rotation of said shafts such that said table moves in said longitudinal direction, one of said shafts rotates to wind up the corresponding elongated member therearound, and the other of said shafts rotates to unwind the corresponding elongated member therefrom so as to move said table in said longitudinal direction by a same specified longitudinal distance by which said stage motion controlling unit moves said drive stage in said longitudinal direction.

7. The cable tray assembly of claim 2 wherein said stage motion controlling unit includes a transverse stage motion controlling device that controls motion of said drive stage in said transverse direction and said shaft motion controlling system includes a transverse motion controlling device that controls motion of said shafts in said transverse direction such that said table and said shafts move in said transverse direction by a same specified transverse distance.

8. The cable tray assembly of claim 6 wherein said stage motion controlling unit includes a transverse stage motion controlling device that controls motion of said drive stage in said transverse direction and said shaft motion controlling system includes a transverse motion controlling device that controls motion of said shafts in said transverse direction such that said table and said shafts move in said transverse direction by a same specified transverse distance.

9. A lithography system comprising:
an illumination source;
an optical system;
a reticle stage arranged to retain a reticle;
a working stage;
a stage motion controlling unit that controls motion of said working stage in a specified longitudinal direction and a transverse direction which is perpendicular to said longitudinal direction;
a wafer table placed on said drive stage and arranged to retain a workpiece;
a shaft extending in said transverse direction;
a planar elongated member with one end portion extending in said longitudinal direction and the opposite end portion attached to and wound around said shaft, said elongated member being made of an elastic material and having a naturally arcuate sectional shape in said transverse direction;
a plurality of conduits each attached to said one end portion of said elongated member and to said wafer table at one end; and
a shaft motion controlling system that controls rotation and axial motion of said shaft in correlation with a motion of said working stage by said stage motion controlling unit.

10. The lithography system of claim 9 comprising a pair of shafts extending in said transverse direction and said planar elongated member is one of a pair of similarly structured elongated members each with one end portion extending in said longitudinal direction and having conduits attached thereto and the opposite end portion wound around a corresponding one of said shafts.

11. The lithography system of claim 9 wherein said stage motion controlling unit includes a longitudinal stage motion controlling device that controls motion of said working stage in said longitudinal direction and said shaft motion controlling system includes a rotation controlling device that controls rotation of said shaft such that said wafer table moves in said longitudinal direction and said shaft rotates to wind or unwind said elongated member around or from said shaft so as to move said wafer table in said longitudinal direction by a same specified longitudinal distance by which said stage motion controlling unit moves said working stage in said longitudinal direction.

12. The lithography system of claim 9 wherein said stage motion controlling unit includes a transverse stage motion controlling device that controls motion of said working stage in said transverse direction and said shaft motion controlling system includes a transverse motion controlling device that controls motion of said shaft in said transverse direction such that said wafer table and said shaft move in said transverse direction by a same specified transverse distance.

13. The lithography system of claim 11 wherein said stage motion controlling unit includes a transverse stage motion controlling device that controls motion of said working stage in said transverse direction and said shaft motion controlling system includes a transverse motion controlling device that controls motion of said shaft in said transverse direction such that said wafer table and said shaft move in said transverse direction by a same specified transverse distance.

14. The lithography system of claim 10 wherein said stage motion controlling unit includes a longitudinal stage motion controlling device that controls motion of said working stage in said longitudinal direction and said shaft motion controlling system includes a rotation controlling device that controls rotation of said shafts such that said wafer table moves in said longitudinal direction, one of said shafts rotates to wind up the corresponding elongated member therearound, and the other of said shafts rotates to unwind the corresponding elongated member therefrom so as to move said wafer table in said longitudinal direction by a same specified longitudinal distance by which said stage motion controlling unit moves said working stage in said longitudinal direction.

15. The lithography system of claim 10 wherein said stage motion controlling unit includes a transverse stage motion controlling device that controls motion of said working stage in said transverse direction and said shaft motion controlling system includes a transverse motion controlling device that controls motion of said shafts in said transverse direction such that said wafer table and said shafts move in said transverse direction by a same specified transverse distance.

16. The lithography system of claim 14 wherein said stage motion controlling unit includes a transverse stage motion controlling device that controls motion of said working stage in said transverse direction and said shaft motion controlling system includes a transverse motion controlling device that controls motion of said shafts in said transverse direction such that said wafer table and said shafts move in said transverse direction by a same specified transverse distance.

17. A lithography system comprising:
an illumination source;
an optical system;
a reticle stage;
a stage motion controlling unit that controls motion of said reticle stage in a specified longitudinal direction and a transverse direction which is perpendicular to said longitudinal direction;
a wafer table placed on said drive stage and arranged to retain a reticle;
a shaft extending in said transverse direction;
a planar elongated member with one end portion extending in said longitudinal direction and the opposite end portion attached to and wound around said shaft, said elongated member being made of an elastic material and having a naturally arcuate sectional shape in said transverse direction;
a plurality of conduits each attached to said one end portion of said elongated member and to said wafer table at one end;
a shaft motion controlling system that controls rotation and axial motion of said shaft in correlation with a motion of said reticle stage by said stage motion controlling unit;
a working stage arranged to retain a workpiece; and
an enclosure that surrounds at least a portion of the working stage, the enclosure having a sealing surface.

18. The lithography system of claim 17 comprising a pair of shafts extending in said transverse direction and said planar elongated member is one of a pair of similarly structured elongated members each with one end portion extending in said longitudinal direction and having conduits attached thereto and the opposite end portion wound around a corresponding one of said shafts.

19. The lithography system of claim 17 wherein said stage motion controlling unit includes a longitudinal stage motion controlling device that controls motion of said reticle stage in said longitudinal direction and said shaft motion controlling system includes a rotation controlling device that controls rotation of said shaft such that said wafer table moves in said longitudinal direction and said shaft rotates to wind or unwind said elongated member around or from said shaft so as to move said wafer table in said longitudinal direction by a same specified longitudinal distance by which said stage motion controlling unit moves said reticle stage in said longitudinal direction.

20. The lithography system of claim 17 wherein said stage motion controlling unit includes a transverse stage motion controlling device that controls motion of said reticle stage in said transverse direction and said shaft motion controlling system includes a transverse motion controlling device that controls motion of said shaft in said transverse direction such that said wafer table and said shaft move in said transverse direction by a same specified transverse distance.

21. The lithography system of claim 19 wherein said stage motion controlling unit includes a transverse stage motion controlling device that controls motion of said reticle stage in said transverse direction and said shaft motion controlling system includes a transverse motion controlling device that controls motion of said shaft in said transverse direction such that said wafer table and said shaft move in said transverse direction by a same specified transverse distance.

22. The lithography system of claim 18 wherein said stage motion controlling unit includes a longitudinal stage motion controlling device that controls motion of said reticle stage in said longitudinal direction and said shaft motion controlling system includes a rotation controlling device that controls rotation of said shafts such that said wafer table moves in said longitudinal direction, one of said shafts rotates to wind up the corresponding elongated member therearound, and the other of said shafts rotates to unwind the corresponding elongated member therefrom so as to move said wafer table in said longitudinal direction by a same specified longitudinal distance by which said stage motion controlling unit moves said reticle stage in said longitudinal direction.

23. The lithography system of claim 16 wherein said stage motion controlling unit includes a transverse stage motion controlling device that controls motion of said reticle stage in said transverse direction and said shaft motion controlling system includes a transverse motion controlling device that controls motion of said shafts in said transverse direction such that said wafer table and said shafts move in said transverse direction by a same specified transverse distance.

24. The lithography system of claim 22 wherein said stage motion controlling unit includes a transverse stage motion controlling device that controls motion of said reticle stage in said transverse direction and said shaft motion controlling system includes a transverse motion controlling device that controls motion of said shafts in said transverse direction such that said wafer table and said shafts move in said transverse direction by a same specified transverse distance.

25. An object manufactured with the lithography system of claim 9.

26. An object manufactured with the lithography system of claim 17.

27. A wafer on which an image has been formed by the lithography system of claim 9.

28. A wafer on which an image has been formed by the lithography system of claim 17.

29. A method for making an object using a lithography process, wherein the lithography process utilizes a lithography system as recited in claim 9.

30. A method for making an object using a lithography process, wherein the lithography process utilizes a lithography system as recited in claim 17.

31. A method for patterning a wafer using a lithography process, wherein the lithography process utilizes a lithography system as recited in claim 9.

32. A method for patterning a wafer using a lithography process, wherein the lithography process utilizes a lithography system as recited in claim 17.
